(19) United States
(12) Patent Application Publication
(10) Pub. No.: US 2014/0224938 A1
(43) Pub. Date: Aug. 14, 2014

(54) Airship

(71) Applicant: Philip Richard Barber, Kalamazoo, MI (US)

(72) Inventor: Philip Richard Barber, Kalamazoo, MI (US)

(21) Appl. No.: 13/907,320

(22) Filed: May 31, 2013

Related U.S. Application Data
(63) Continuation of application No. 13/767,844, filed on Feb. 14, 2013.

(51) Int. Cl. B64B 1/06; B64B 1/20; B64D 45/00; B64G 1/40; B64G 1/26; B64B 1/58; B64B 1/12; B64B 1/22

(52) U.S. Cl. CPC B64B 1/06; B64B 1/12; B64B 1/20; B64B 1/22; B64G 1/40; B64G 1/26; B64B 1/58; B64D 45/00
USPC 244/164

(57) ABSTRACT

An improved airship having a plurality of resilient gasbags & gas containers, a straight fuselage tubular hull with an inner air passageway & propulsion means located therein, connecting air inlet & outlet funnels fore & aft, with air deflector cones axially positioned therein, and a plurality of bifurcated winged air control surfaces axially affixed vertically & horizontally across the air inlet & outlet funnels fore & aft; further, a plurality of vectored air passageways & mechanisms, and propulsion, reverse, & directional rocket thrusters, positioned fore & aft, top, bottom, port & starboard; thereby providing improved speed, maneuverability, efficiency, adverse weather capability, reduced forward air resistance, & rearward drag; furthermore space, outer & inner atmosphere ingress & egress.

### CROSS REFERENCE TO RELATED APPLICATIONS

United States Patent and Trademark Office, provisional patent application No. 61/598,879, filing date Feb. 14, 2012, invention title: Ultra Low Drag Forward Resistance & Snag Airship; and United States Patent and Trademark Office, non-provisional patent application Ser. No. 13/767,844 filing date Feb. 14, 2013, invention title: Improved Airship

### FEDERALLY SPONSORED RESEARCH

not applicable

### SEQUENCE LISTING OR PROGRAM

not applicable

### BACKGROUND OF THE INVENTION

The present invention relates to airships and more particularly to airships having internal or ducted propulsion systems.

Airships are well known, and have grown in popularity in recent years.

It is also well known that airships or dirigible type of aircraft are useful where: quite, the ability to hover in one place for an extended period, and to land in un-developed areas are desired. Yet conventional designs are lacking for speed, efficiency, and maneuverability. And, that previous airship designs are slow, sluggish, inefficient and, incapable in high-wind gusts & adverse weather; further yet lacking: air inlet & outlet vectoring, or propulsive, directional, & attidudinal control in the atmosphere, the outer atmosphere & space.

Over the years there have been numerous improvements made to airships, and many designs to solve the problems described above.

These designs have generally been concentrated on the area of control, propulsion, and aerodynamics, yet the best designs do not adequately solve the problems of slow, sluggish, inefficient, high-wind-gust adverse-weather incapability, or propulsive, directional, & attidudinal control in the atmosphere, outer atmosphere, & space to a satisfactory degree.

### BACKGROUND PRIOR ART DISCUSSION

U.S. Pat. No. 6,607,163 discloses a conventional conical shaped airship with near space buoyancy and propulsion means however it does not have a tubular straight fuselage, non-protruding attitudinal control wings, air deflector cones, an inner air passageway, internal propulsion means, air inlet & outlet vectoring mechanisms, or propulsive, directional, & attidudinal control means in the atmosphere, the outer atmosphere & space.

U.S. Pat. No. 5,071,090 shows a conventional conical shaped airship with an internal air passageway, and internal propulsion means, however it does not have a tubular straight fuselage, non-protruding attitudinal control wings, air deflector cones, air inlet & outlet vectoring mechanisms, or propulsive, directional, & attidudinal control means in the atmosphere, the outer atmosphere & space.

U.S. Pat. No. 4,967,983 describes an airfoil type airship with an internal air passageway, however it does not have a tubular straight fuselage, non-protruding attitudinal control wings, air deflector cones, air inlet & outlet vectoring mechanisms, or propulsive, directional, & attidudinal control means in the atmosphere, the outer atmosphere & space.

U.S. Pat. No. 1,835,260 shows a conventional conical shaped airship with an internal air passageway, and internal propulsion means, however it does not have a tubular straight fuselage, non-protruding attitudinal control wings, air deflector cones, air inlet & outlet vectoring mechanisms, or propulsive, directional, & attidudinal control means in the atmosphere, the outer atmosphere & space.

U.S. Pat. No. 2,384,893 shows an airfoil airship having an internal air passage way however it does not have a tubular straight fuselage, non-protruding attitudinal control wings, air deflector cones, air inlet & outlet vectoring mechanisms, or propulsive, directional, & attidudinal control means in the atmosphere, the outer atmosphere & space.

U.S. Pat. No. 3,288,397 shows a tri-hull airship airfoil having 3 conventional elliptical shaped airship fuselages affixed together comprising an air-ship airfoil; having external control apertures, and external propulsion means. However it does not have a tubular straight fuselage, non-protruding attitudinal control wings, air deflector cones, an inner air passageway, an internal propulsion means, air inlet & outlet vectoring mechanisms, or propulsive, directional, & attidudinal control means in the atmosphere, the outer atmosphere & space.

### SUMMARY OF THE INVENTION

A main advantage of the present invention is providing an improved airship that attempts to solve the problems of conventional airships detailed herein by incorporating one or more of the characteristics discussed in the embodiments listed below.

Accordingly several advantages of one or more aspects of the present invention are to provide an airship having improved: speed performance, maneuverability, efficiency, adverse weather capability and means of space ingress & egress.

It is further an advantage of the invention to provide an airship with reduced air displacement, forward air resistance, and rearward drag of the airship.

It is another advantage of the invention to provide an airship with improved airflow direction into, out of, and around the airship.

It is yet another advantage of the invention to provide an airship with improved attitudinal, directional, pitch, roll, & yaw, control, further improved airflow control into, out of, and around the airship.

It is a further advantage of the invention to provide an airship with a means to vector airflow into and out of the airship, fore, aft, top, bottom, port & starboard.

It is still yet a further advantage of the invention to provide an airship with the means to move directionally, laterally, vertically, and to pitch, yaw & roll with substantially no forward or reverse movement.

It is still another advantage of the invention to provide an improved airship with propulsive, attitudinal & directional control in space, air atmosphere, and transition to and from thereof.

The foregoing and other advantages are realized by providing a linear straight tubular shaped fuselage, having an inner air passageway axially extending there-through tapering inwardly from the furthest circumferential peripheral exterior edges of the fuselage fore, toward the interior mid region of the airship like a funnel, forming an air inlet in the fuselage fore, which then connects to the inner air passageway; propelling air into and out of the airship is the propulsion system located inside the inner air passageway which extends downstream and continues to the airship aft tapering outwardly like a funnel to the furthest circumferential peripheral exterior edges of the fuselage aft forming an air outlet in the aft of the fuselage. This causes air to be transported from the front of the airship, into and through the inner air passageway out of and behind the airship, thereby moving the airship through the air.

The straight tubular shaped fuselage also having a plurality of air deflector cones axially centrally positioned substantially inside and extending from the air inlet and outlet openings fore and aft in the fuselage, connect-ably affixed to the air inlet funnel and fuselage which direct airflow into and out of the airship to the circumferential peripheral regions of the air inlet and outlet openings, into out-of and through the inner air passageway which extends axially through the fuselage, thereby directing the airflow into, through, and out of the airship fuselage. The plurality of airship deflector cones further providing containment for a plurality of lighter than air resilient gas bags thereby providing dynamic buoyant lift further adding to the airships buoyancy. Further a plurality of bifurcated active and non-active winged control surfaces located at the fore and aft of the air inlet and outlet inner air way openings. The winged control surfaces being positioned horizontally and vertically across the inner air way openings, having the active control surfaces being rotate-ably, hinge-ably attached to the non-active control surfaces, and a plurality of actuators attached between the air intake and air outlet sections of the fuselage and to the control surfaces thereby operate-ably, rotate-ably, actuating the hinged active control surfaces respective to their non-active control surfaces. Thereby operate-ably, controlling direction of air flow into the air inlet opening and out of the air outlet opening; controlling direction, pitch, roll and yaw, of the airship.

Furthermore a plurality of vectored air passageways & air vectoring mechanisms positioned & affixed fore, aft, port, starboard, top, and bottom, in the airship straight fuselage tubular hull connect to the fuselage inner air passageway containing the propulsion means whereby air flow is drawn into the airship fuselage inner-air passageway inlet funnel or air vectoring passageways & mechanisms, as determined by the position of the inner air & vectored air passageway-air diverter cone valve mechanisms & vectored air passageway-air control valve mechanisms. The airflow being propelled through the fuselage inner air passageway by the propulsion means contained therein, and out through the airship fuselage inner-air passageway outlet funnel, or air vectoring passageways & mechanisms as determined by the position of the inner air & vectored air passageway-air diverter cone valve mechanisms & vectored air passageway-air control valve mechanisms; thereby vectoring airflow into and out of the airship, fore, aft, top, bottom, port & starboard, providing further means of operate-ably, controlling the airship direction, lateral, vertical, pitch, roll & yaw movement with substantially no forward or reverse movement.

Still yet further a plurality of rocket engine thruster nozzles affixed and positioned fore, aft, top, bottom, port & starboard in the airship fuselage and fuselage air deflector cones provide means for propulsion, directional, & attitudinal control, and a plurality of resilient gas bags provide means of dynamic lift thereby providing means for airship ingress & egress from space, the outer atmosphere and the inner atmosphere wherein oxygen levels sufficient for jet engine propulsion provide means for airship direction & control.

The result is an improved airship having reduced air displacement, forward air resistance, rearward drag, fuel economy, speed performance, maneuverability, efficiency, adverse weather capability and means of space ingress & egress.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which FIGS. 1 thru 10, 10A, 11, 11A, and, 12, thru 44 illustrate various views of embodiments of the present invention wherein:

FIG. 1 is a sectional perspective view of the tubular airship;

FIG. 2 is a sectional side view of the tubular airship;

FIG. 3 is a sectional side view of the tubular airship showing the aerodynamic flow through, around, over and under the fuselage;

FIG. 4 is a sectional side view of the tubular airship showing the aerodynamic flow through, around, over and under the tri-tube airship fuselage embodiment of the present invention;

FIG. 5 is a schematic sectional end view showing the tri-tube airship fuselage embodiment of the present invention;

FIG. 6 is a sectional top or bottom view showing the tri-tube airship fuselage embodiment of the present invention;

FIG. 7 is a schematic sectional aft view of the present invention;

FIG. 8 is a schematic sectional aft view of the present invention;

FIG. 9 is a sectional perspective view of the tubular airship showing the aft control surface only embodiment of the present invention;

FIG. 10 is a sectional perspective view of the airship showing the tubular airship polygonal radar resistant fuselage embodiment of the present invention;

FIG. 10A is a sectional perspective partial view of the airship showing the aerodynamic control surfaces of the radar resistant fuselage embodiment of the present invention;

FIG. 11 is a sectional perspective view of the airship showing the propulsion rocket thrust nozzle, directional control rocket thruster nozzles, and reverse rocket thrust nozzle of the airship spaceship embodiment of the present invention;

FIG. 11A is a sectional schematic end view of the airship showing the propulsion rocket thrust nozzle, and directional control rocket thruster nozzles of the airship spaceship embodiment of the present invention;

FIG. 12 is a sectional perspective view of the tubular airship showing the vectored air passageways & air vectoring mechanisms fore, aft, top, and starboard showing the air vectoring mechanism doors in the closed position;

FIG. 13 is a sectional perspective view of the tubular airship showing the vectored air passageway & air vectoring mechanism fore, aft, top, and starboard, showing the air vectoring mechanism doors in the open position;

FIG. 14 is a sectional side view of the tubular airship fore showing the straight fuselage tubular hull, fuselage air inlet, fuselage air deflector cone fore, fuselage inner-air passageway inlet funnel, fuselage inner-air passageway, vectored air passageway fore top & bottom, and air vectoring mechanisms fore top & bottom, the inner air & vectored air passageway air diverter cone valve mechanism, and vectored air passageway air control valve mechanisms;

FIG. 15 is a sectional side view of the tubular airship fore as shown in FIG. 14 showing the air vectoring mechanism fore top & bottom, the inner air passageway air diverter cone valve mechanism, and vectored air passageway air control valve mechanisms configured to vector the air flow into the airships fore through the fuselage inner-air passageway inlet funnel, into the fuselage inner air passageway;

FIG. 16 is a sectional side view of the tubular airship fore as shown in FIG. 14 showing the air vectoring mechanism fore top & bottom, the inner air passageway air diverter cone valve mechanism, and vectored air passageway air control valve mechanisms vectoring the air flow into the airships fore through the fuselage inner-air passageway inlet funnel, into the fuselage inner air passageway;

FIG. 17 is a sectional side view of the tubular airship fore as shown in FIG. 14 showing the air vectoring mechanism fore top & bottom, with the fuselage air control fin doors in the open position, the fore inner air passageway air diverter cone valve mechanism, and fore vectored air passageway air control valve mechanisms configured to vector the air flow into the airships fore through the, intake airway air vectoring mechanism fore top & bottom, and through the fuselage inner-air passageway inlet funnel, into the fuselage inner air passageway;

FIG. 18 is a sectional side view of the tubular airship fore as shown in FIG. 14 showing the air vectoring mechanism fore top & bottom, with the fuselage air control fin doors in the open position, the fore inner air passageway air diverter cone valve mechanism, and fore vectored air passageway air control valve mechanisms vectoring the air flow into the airships fore through the, intake airway air vectoring mechanism fore top & bottom, and through the fuselage inner-air passageway inlet funnel, into the fuselage inner air passageway;

FIG. 19 is a sectional side view of the tubular airship fore as shown in FIG. 14 showing the air vectoring mechanism fore top & bottom, with the fuselage air control fin doors in the open position, the inner air passageway air diverter cone valve mechanism, and vectored air passageway air control valve mechanisms configured to vector the air flow into the airships intake airway air vectoring mechanism fore top & bottom, and into the fuselage inner air passageway;

FIG. 20 is a sectional side view of the tubular airship fore as shown in FIG. 14 showing the air vectoring mechanism fore top & bottom, with the fuselage air control fin doors in the open position, the inner air passageway air diverter cone valve mechanism, and vectored air passageway air control valve mechanisms vectoring the air flow into the airships intake airway air vectoring mechanism fore top & bottom, and into the fuselage inner air passageway;

FIG. 21 is a sectional side view of the tubular airship aft showing the straight fuselage tubular hull, fuselage air outlet, fuselage air deflector cone aft, fuselage inner-air passageway outlet funnel, fuselage inner-air passageway, vectored air passageway aft top & bottom, and air vectoring mechanisms aft top & bottom, the inner air & vectored air passageway air diverter cone valve mechanism, and vectored air passageway air control valve mechanisms;

FIG. 22 is a sectional side view of the tubular airship aft as shown in FIG. 21 showing the air vectoring mechanism aft top & bottom, the inner air passageway air diverter cone valve mechanism, and vectored air passageway air control valve mechanism, configured to vector the air flow out of the airships aft through the fuselage inner-air passageway outlet funnel;

FIG. 23 is a sectional side view of the tubular airship aft as shown in FIG. 21 showing the air vectoring mechanism aft top & bottom, the inner air passageway air diverter cone valve mechanism, and vectored air passageway air control valve mechanism vectoring the air flow out of the airships aft through the fuselage inner-air passageway outlet funnel;

FIG. 24 is a sectional side view of the tubular airship aft as shown in FIG. 21 showing the air vectoring mechanism aft top & bottom, with the fuselage air control fin doors in the open position, the inner air passageway air diverter cone valve mechanism, and vectored air passageway air control valve mechanisms configured to vector the air flow out of the airships aft through the fuselage inner-air passageway outlet funnel, and through the airway air vectoring mechanism aft top & bottom;

FIG. 25 is a sectional side view of the tubular airship all as shown in FIG. 21 showing the air vectoring mechanism aft top & bottom, with the fuselage air control fin doors in the open position, the inner air passageway air diverter cone valve mechanism, and vectored air passageway air control valve mechanisms vectoring the air flow out of the airships aft through the fuselage inner-air passageway outlet funnel, and through the airway air vectoring mechanism all top & bottom;

FIG. 26 is a sectional side view of the tubular airship aft as shown in FIG. 21 showing the air vectoring mechanism aft top & bottom, with the fuselage air control fin doors in the open position, the inner air passageway air diverter cone valve mechanism, and vectored air passageway air control valve mechanisms configured to vector the air flow out of the airships aft through the fuselage inner-air passageway outlet funnel, and through the air vectoring mechanisms aft top & bottom;

FIG. 27 is a sectional side view of the tubular airship aft as shown in FIG. 21 showing the air vectoring mechanism aft top & bottom, with the fuselage air control fin doors in the open position, the inner air passageway air diverter cone valve mechanism, and vectored air passageway air control valve mechanisms vectoring the air flow out of the airships aft through the fuselage inner-air passageway outlet funnel, and through the air vectoring mechanisms aft top & bottom;

FIG. 28 is a sectional side view of the tubular airship aft top showing the aft fuselage air deflector cone fuselage inner-air passageway outlet funnel aft vectored air passageway, and aft air vectoring mechanism; configured to vector the air flow out of the fuselage inner-air passageway outlet funnel, and the air vectoring mechanism aft top,

FIG. 29 is a sectional side view of the tubular airship fore top showing the fore fuselage air deflector cone fuselage inner-air passageway inlet funnel, fore vectored air passageway, and fore air vectoring mechanism; configured to vector the air flow into the airship fuselage inner-air passageway inlet funnel, and the air vectoring mechanism fore top;

FIG. 30 is a sectional side view of the tubular airship fore top as described in FIG. 29 showing the vectored air passageway & air vectoring mechanism fore top, vectoring the air flow into the airships fore top intake air vectoring mechanism, vectoring inlet air flow downwardly & abaft the airship fore top;

FIG. 31 is a sectional side view of the tubular airship fore top as described in FIG. 29 showing the vectored air passageway & air vectoring mechanism fore top, vectoring the air flow into the airships fore top intake air vectoring mechanism, vectoring inlet air flow downwardly of the airship fore top;

FIG. 32 is a sectional side view of the tubular airship fore top as described in FIG. 29 showing the vectored air passageway & air vectoring mechanism fore top, vectoring the air flow into the airships fore top intake air vectoring mechanism, vectoring inlet air flow afore the airship fore through the fore fuselage inner-air passageway inlet funnel;

FIG. 33 is a sectional side view of the tubular airship fore top as described in FIG. 29 showing the vectored air passageway & air vectoring mechanism fore top, vectoring the air flow into the airships fore top air vectoring mechanism, vectoring inlet air flow downwardly & afore the airship fore;

FIG. 34 is a sectional side view of the tubular airship aft top as described in FIG. 28 showing the vectored air passageway aft top & air vectoring mechanism aft top, vectoring the air flow out of the airships aft top air vectoring mechanism vectoring outlet air flow abaft the airship aft;

FIG. 35 is a sectional side view of the tubular airship aft top as described in FIG. 28 showing the vectored air passageway aft top & air vectoring mechanism aft top, vectoring the air flow out of the airships aft top air vectoring mechanism vectoring outlet air flow upwardly of the airship aft;

FIG. 36 is a sectional side view of the tubular airship aft top as described in FIG. 28 showing the vectored air passageway aft top & air vectoring mechanism aft top ,vectoring the air flow out of the airships aft top air vectoring mechanism vectoring outlet air flow abaft the airship aft through the aft fuselage inner-air passageway outlet funnel;

FIG. 37 is a sectional side view of the tubular airship aft top as described in FIG. 28 showing the vectored air passageway aft top & air vectoring mechanism aft top, vectoring the air flow out of the airships aft top air vectoring mechanism vectoring outlet air flow upwardly & afore the airship aft;

FIG. 38 is an aft view of the airship fuselage straight tubular hull showing the vectored air passageway air vectoring mechanisms, top, bottom, port & starboard and, the aft bifurcated active & non active horizontal & vertical attitudinal control wings, and fuselage air deflector cone aft;

FIG. 39 is a fore view of the airship fuselage straight tubular hull showing the inlet air vectoring mechanism fore top vectoring inlet air flow downwardly of the airship fore top;

FIG. 40 is a sectional fore view of the present invention showing the inlet air vectoring mechanism fore top vectoring inlet air flow downwardly & astarboard the airship fore top;

FIG. 41 is a sectional fore view of the present invention showing the inlet air vectoring mechanism fore top vectoring inlet air flow downwardly & aport the airship fore top;

FIG. 42 is a sectional aft view of the present invention showing the outlet air vectoring mechanism aft top vectoring outlet air flow upwardly of the airship aft top;

FIG. 43 is a sectional aft view of the present invention showing the outlet air vectoring mechanism aft top vectoring outlet air flow upwardly & astarboard the airship aft top;

FIG. 44 is a sectional aft view of the present invention showing the outlet air vectoring mechanism aft top vectoring outlet air flow upwardly & aport the airship aft top;

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “affixed,” “connect” or terms similar thereto are often used. They are not limited to direct connection but include connection through other elements where such connection is recognized as being equivalent by those skilled in the art.

### DESCRIPTION OF THE PREFERRED EMBODIMENT

The present invention and the various features and advantageous details thereof are explained more fully with reference to the non-limiting embodiments described in detail in the following description.

Various alternative embodiments and modifications to the invention will be made apparent to one of ordinary skill in the art by the following detailed description taken together with the drawings.

Accordingly it will also be understood the present invention as disclosed herein shall include materials & equipment including but not limited to pluralities of heat shields, motors, compressors, fuel tanks, pumps, pipes, valves, hoses, fittings, hydraulics, solenoids, actuators, batteries, computers, electronics, sensors, receivers, guidance & control systems, electronics, motors, servos, wires, connectors, connecting rods, composites, laminates, fabrics, carbon fiber, aluminum, titanium, gaskets, fasteners, adhesives, sealants, lubricants, gases, gaseous liquids, liquids, propulsive fuels, and all other materials, parts, equipment & apparatus common to airship, aircraft and spacecraft construction shall be used.

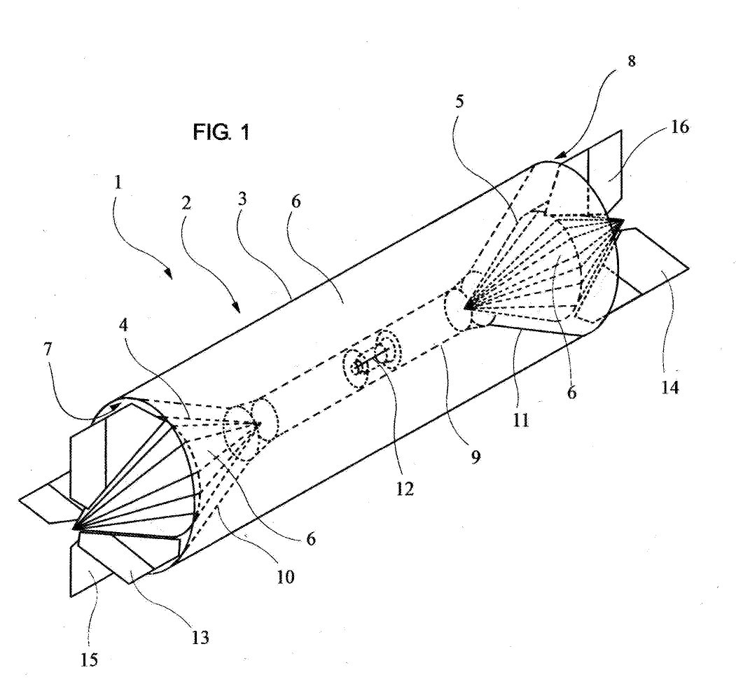

Referring now to FIG. 1, it will be seen a preferred embodiment of the invention; a tubular airship made in accordance with the present invention designated generally by reference numeral 1, is shown with it's primary components.

The tubular airship 1, has a linear straight tubular shaped fuselage designated generally by reference numeral 2.

Fuselage 2, having 6 sections: a linear straight tubular hull 3, an air deflector cone aft 4, an air deflector cone fore 5, an inner air passageway 9, an inner- air passageway outlet funnel 10, an inner-air passageway inlet funnel 11.

The fuselage 2, tubular hull 3, inner air passageway 9, extends axially there-through the tubular hull 3, tapering inwardly from the furthest circumferential peripheral exterior edges in fore of tubular hull 3, forming inner air passageway inlet funnel 11, in fore of tubular hull 3, connecting to inner air passageway 9, axially extending downstream continuing to airship fuselage air outlet aft tapering outwardly to the furthest circumferential peripheral exterior edges in aft of tubular hull 3, forming inner air passageway outlet funnel 10, in aft of tubular hull 3.

The fuselage 2, further shown having fuselage air deflector cone fore 5, positioned centrally substantially inside and extending from fuselage air inlet 8, connect-ably affixed to the airship fuselage tubular hull 3, fuselage inner air passageway inlet funnel 11 so as to allow for an air passageway between the fuselage inner air passageway inlet funnel 11, and the fuselage air deflector cone fore 5.

Air deflector cone fore 5, position further defined as centrally substantially located inside and extending out of fuselage inner air passageway inlet funnel 11, connecting to inner air passageway 9, containing propulsion means 12, centrally axially located within inner air passageway 9, which is connected to inner air passageway outlet funnel 10, forming air outlet 7, having air deflector cone aft 4, positioned centrally substantially inside and extending from fuselage air outlet 7.

Air deflector cone aft 4, position further defined as centrally substantially located inside and extending out of fuselage inner air passageway outlet funnel 10, connect-ably affixed to the airship fuselage tubular hull 3, and the fuselage inner air passageway outlet funnel 10, so as to allow for an air passageway between the fuselage inner air passageway inlet funnel 11, and the fuselage air deflector cone aft 4.

The fuselage air deflector cones direct air flow to the circumferential perimeters of the airship air inlets and outlets, thereby minimizing forward air resistance and rearward drag.

The linear straight tubular airship 1, further shown having all bifurcated active & non active horizontal attitudinal control wings rotate-ably, hinge-ably attached 13, and aft bifurcated active & non active vertical attitudinal control wings rotate-ably, hinge-ably attached 15, affixed to a plurality of actuators connected between fuselage inner air passageway outlet funnel 10, and the fuselage air deflector cone aft 4, in the fuselage air outlet 7.

It will be further understood the linear straight tubular airship 1, further shown having fore bifurcated active & non active horizontal attitudinal control wings rotate-ably, hinge-ably attached 14, and, fore bifurcated active & non active vertical attitudinal control wings rotate-ably, hinge-ably attached 16, affixed to a plurality of actuators connected between fuselage inner air passageway inlet funnel 11, and the fuselage air deflector cone fore 5, in the fuselage air inlet 8. Thereby actuate-ably controlling direction of air flow into fuselage air inlet 8, and out of fuselage air outlet 7, providing directional, pitch, roll & yaw control of the linear straight tubular airship 1.

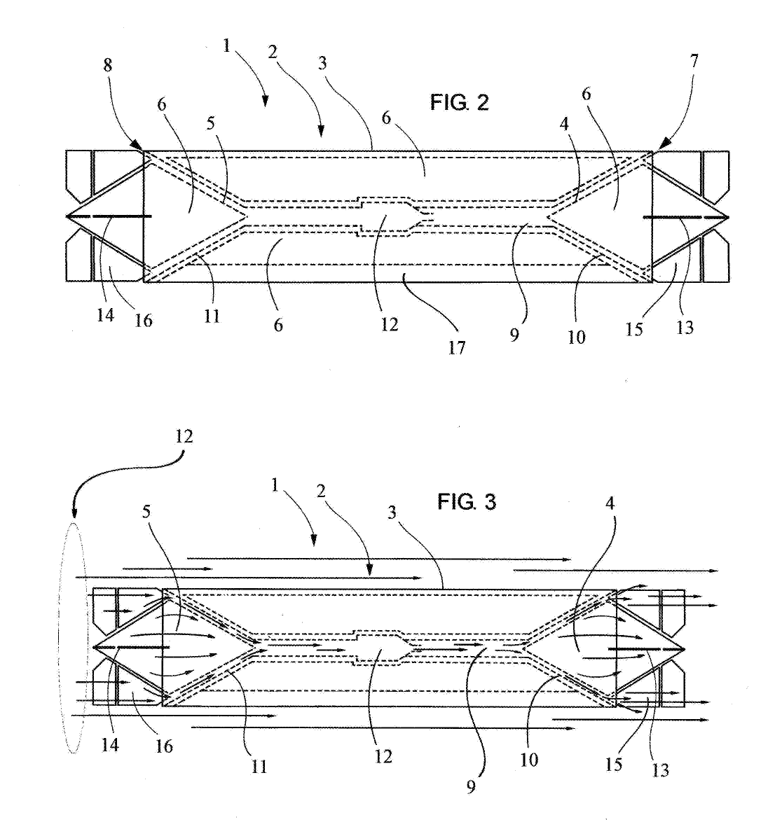

Referring now to FIG. 2 a side schematic view will be seen further showing the primary components of the tubular airship 1, having the fuselage 2, including the fuselage tubular hull 3, the fuselage air deflector cone fore 5, the fuselage air deflector cone aft 4, the fuselage inner air passageway 9, the fuselage inner air passageway outlet funnel 10, the fuselage inner air passageway inlet funnel 11, the propulsion means 12, the horizontal control wings aft 13, the vertical control wings aft 15, the horizontal control wings fore 14, the vertical control wings fore 16, a plurality of resilient gas bags 6, the fuselage air inlet 8, the fuselage air outlet 7, and the cargo & operating equipment bay 17.

Referring to FIG. 3. a schematic side view will be seen, providing an understanding of the airflow 12, into the fuselage inner air passageway inlet funnel 11, over the vertical control wings fore 16, the horizontal control wings fore 14, around the fuselage air deflector cone fore 5, through the fuselage inner air passageway 9, through the propulsion means 12, and out through the fuselage inner air passageway outlet funnel 10, around the fuselage air deflector cone aft 4, over the vertical control wings aft 15, and horizontal control wings aft 13, then out of, and behind the airship. Thus moving the air from in front of the airship, through, and behind the airship, thereby actuate-ably & controllably moving the airship through the air.

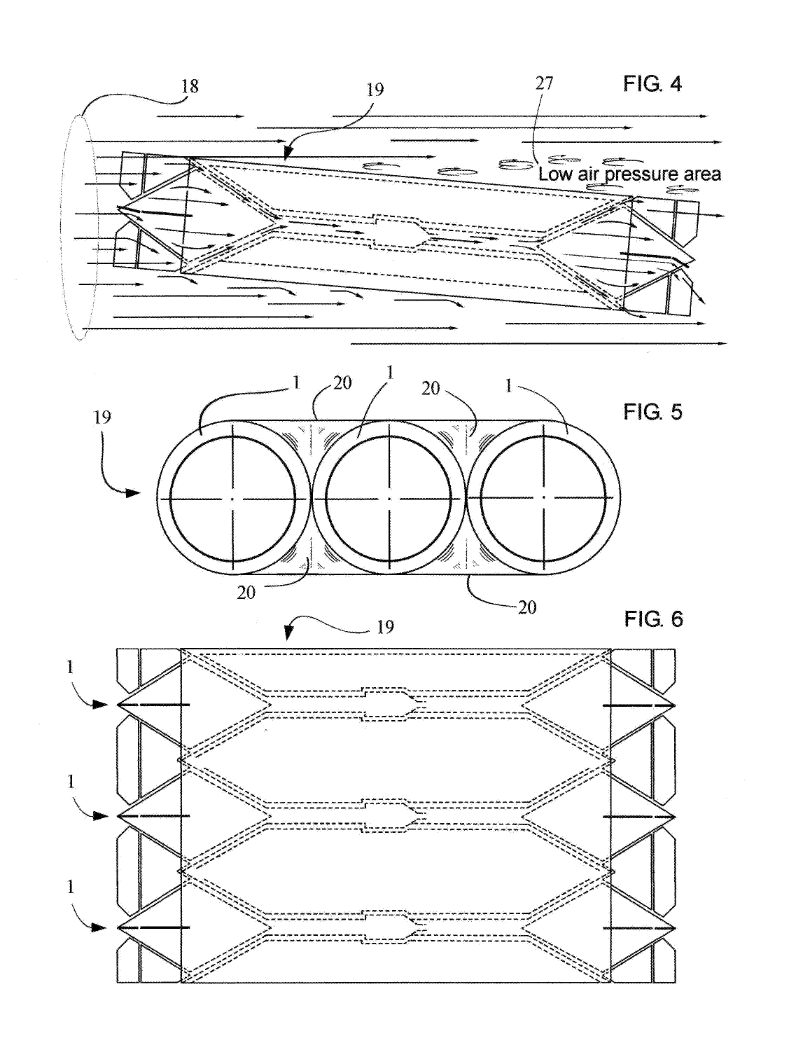

Referring to FIG. 4 a schematic side view of the tubular airship 1, tri-tube airship 19, embodiment of the disclosed invention will be seen. Further it will be understood the airflow 18, into, through, out of, and around the tri-tub airship 19. More particularly the low air pressure area 27, lifting action generated by the tri-tube airships airfoil aerodynamics provided by the tri-tub airship 19, as the airship is positioned relative to oncoming airflow over through, out of, behind, and under the tri-tube airship 19.

Referring now to FIG. 5, a schematic sectional end view will be seen showing the tubular airship 1, tri-tube airship 19, embodiment of the disclosed invention. Further it will be understood that the tri-tube airship 19, comprises a plurality of single tube airships 1, joined and connected together in parallel, having cowlings 20 enclosing the fore and aft fuselage sections of the tri-tube airship 19, affixed between the plurality of single tube tubular airships 1. The tri-tube airship 19, thereby providing an airfoil lift from the tri-tube airship 19, fuselage as shown in FIG. 4, in addition to the tubular airships 1, lift characteristics disclosed herein.

Referring to FIG. 6, a schematic top & bottom view showing a further understanding of the plurality of single tube airships 1, comprising a tri-tube airship 19, embodiment of the present invention.

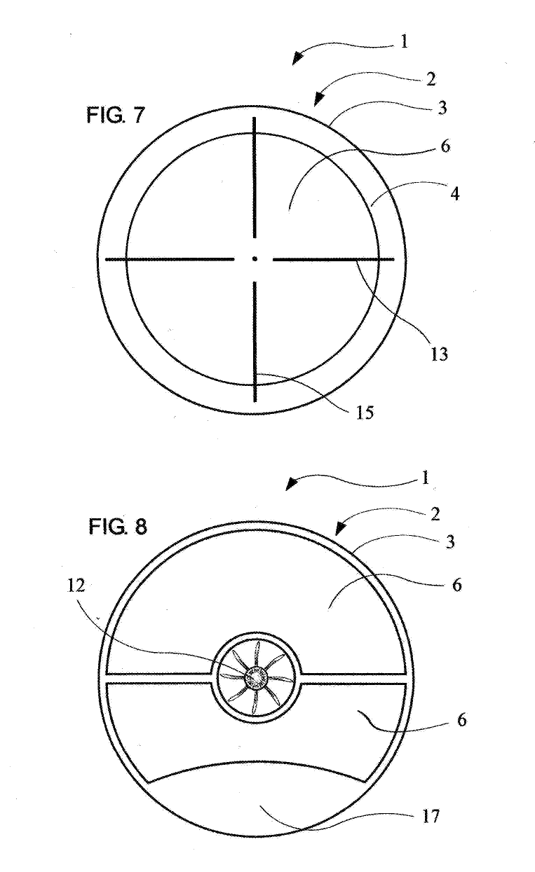

Referring to FIG. 7, a schematic sectional aft view of the present invention will be seen, showing the tubular airship 1, the fuselage 2, the fuselage tubular hull 3, resilient gas bag 6, fuselage air deflector cone aft 4, bifurcated active & non active horizontal attitudinal control wings aft 13, and bifurcated active & non active vertical attitudinal control wings aft 15.

Referring to FIG. 8, a schematic sectional view of the present invention will be seen showing the airship 1, the fuselage 2, the fuselage tubular hull 3, plurality of resilient gas bags 6, cargo & operating equipment bay 17, propulsion means 12.

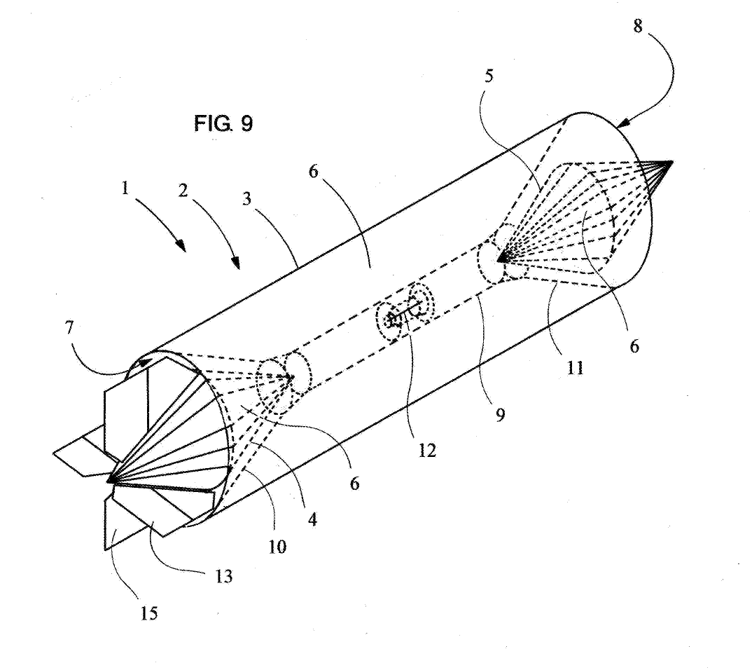

Referring to FIG. 9, a schematic perspective view will be seen of the tubular airship showing the aft bifurcated active & non active attitudinal control wings only embodiment of the present invention having winged control surfaces in the aft fuselage air outlet 7, only of the tubular airship 1; the fuselage air deflector cone fore 5, only, positioned in the fuselage air inlet 8, providing reduced weight and air flow restriction into the fuselage inner air passageway inlet funnel 11. The airship 1, shown having a fuselage 2, fuselage tubular hull 3, plurality of resilient gas bags 6, inner air passageway 9, propulsion means 12, fuselage air deflector cone aft 4, fuselage inner air passageway outlet funnel 10, bifurcated active & non active horizontal attitudinal control wings 13, bifurcated active & non active vertical attitudinal control wings 15, and fuselage air outlet 7.

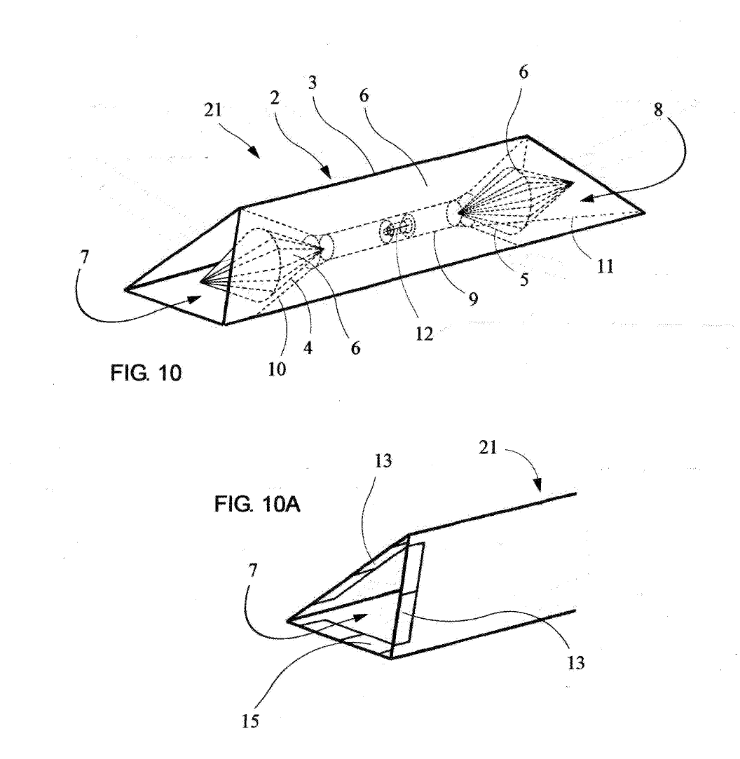

Referring to FIG. 10, it will be seen a sectional perspective view of said tubular airship 1, showing the tubular airship polygonal fuselage 21, embodiment of the present invention.

Wherein it will be seen the fuselage 2, and the tubular hull 3, a plurality of resilient gas bags 6, fuselage air inlet 8, the fuselage inner air passageway inlet funnel 11, the fuselage air deflector cone fore 5, the fuselage inner air passageway 9, the propulsion means 12, the fuselage air deflector cone aft 4, the fuselage inner air passageway outlet funnel 10, the fuselage air outlet 7, providing an understanding of the tubular airship polygonal fuselage embodiment 21, showing the radar wave dissipating angular surfaces of the invention disclosed herein.

Referring to FIG. 10A, it will be seen a sectional perspective partial aft view of said tubular airship 1, showing the tubular airship polygonal fuselage 21, embodiments horizontal control wings aft 15, vertical control wings all 13, and the fuselage air outlet 7; further it will be understood that FIG. 10A shall additionally represent the tubular airship polygonal fuselage 21, embodiments horizontal control wings fore 14, vertical control wings fore 16, and the fuselage air inlet 8, having an identical structure as the airship aft components.

Referring to FIG. 11 it will be understood the airship spaceship 22, embodiment of the present invention, additionally to the invention as defined in FIG. 1, further including a propulsion rocket engine thrust nozzle 23, a plurality of directional control rocket engine thrust nozzles 24, and a reverse rocket engine thrust nozzle 25, thereby providing the means of propulsion, directional, and attitudinal control inside and outside the earth's atmosphere, and in transition to and from thereof. This definition is interpreted as if all of the language of FIG. 1, were incorporated.

Referring to FIG. 11A it will be understood the airship spaceship 22, embodiment of the present invention additionally to the invention as defined in FIG. 1, further including the fuselage tubular hull 3, fuselage air deflector cone aft 4, resilient gas bag 6, the bifurcated active & non active horizontal attitudinal control wings 13, bifurcated active & non active vertical attitudinal control wings 15, and further including a propulsion rocket engine thrust nozzle 23, and a plurality of directional control rocket engine thrust nozzles 24. This definition is interpreted as if all of the language of FIG. 1, were incorporated;

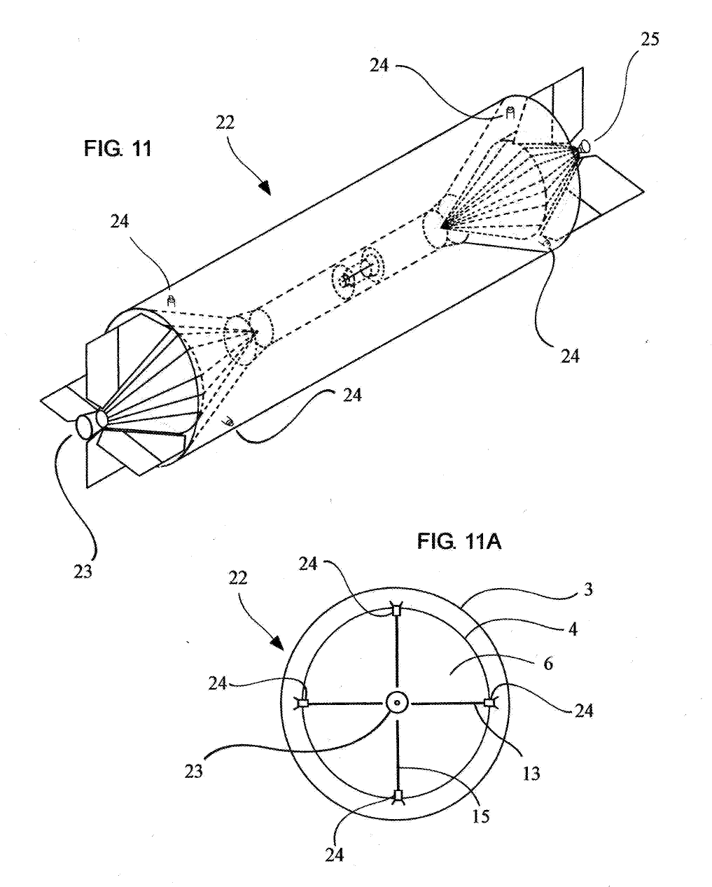

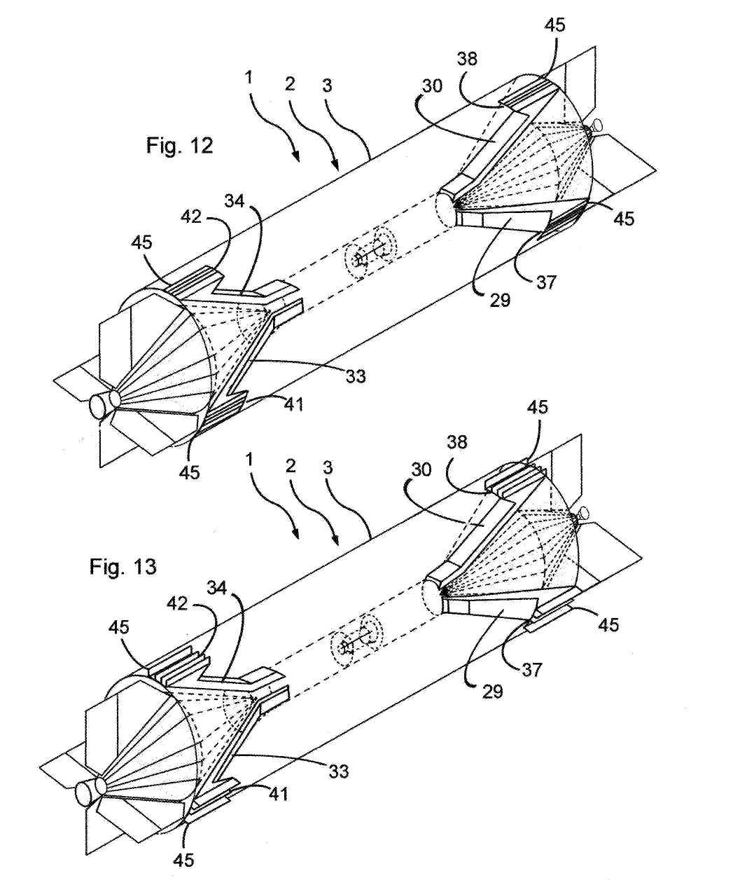

Referring to FIG. 12 a perspective view of the tubular airship 1, as defined in FIG. 1 will be seen having vectored air passageways fore top 30, & fore starboard 29, and aft top 34, & aft starboard 33, and air vectoring mechanisms fore top 38, & fore starboard 37, and aft top 42, & aft starboard 41, showing said air vectoring mechanisms fuselage air control fin doors 45, in the closed position. This definition is interpreted as if all of the language of FIG. 1, were incorporated;

Referring to FIG. 13 a perspective view of the tubular airship 1, as defined in FIG. 1 will be seen having vectored air passageways fore top 30, & fore starboard 29, and aft top 34, & aft starboard 33, and air vectoring mechanisms fore top 38, & fore starboard 37, and aft top 42, & aft starboard 41, showing said air vectoring mechanisms-funnel air control fin doors 46, and air control fins 44, in the open position, This definition is interpreted as if all of the language of FIG. 1, were incorporated.

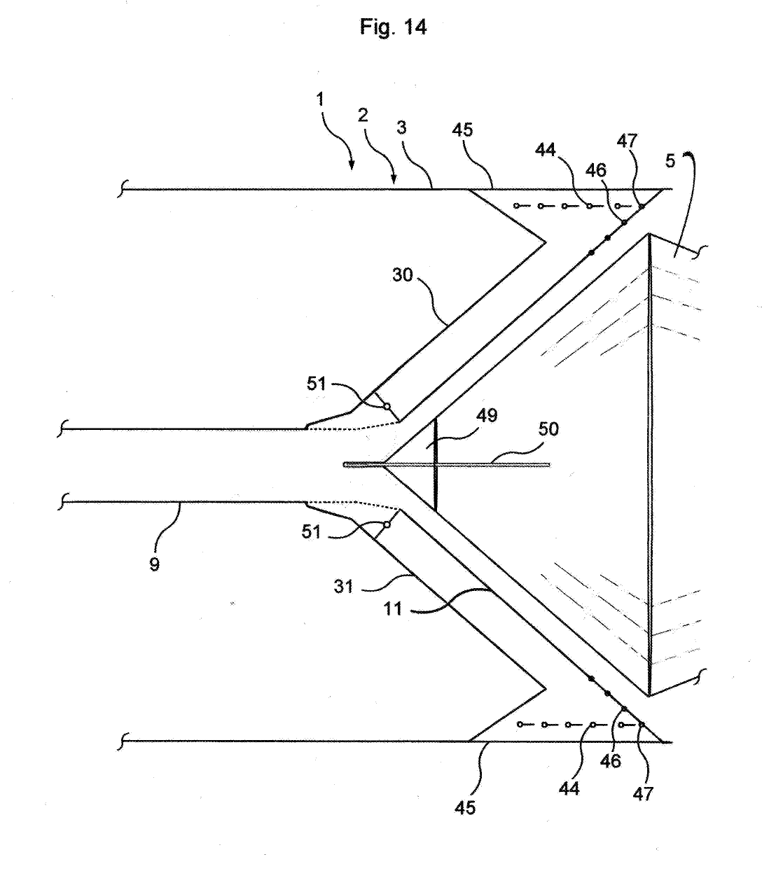

Referring to FIG. 14 a partial side view will be seen of the tubular airship 1, fuselage 2, and straight fuselage tubular hull 3, fore section, and fuselage air deflector cone fore 5, vectored air passageways fore top 30, & fore bottom 31, fuselage inner-air passageway inlet funnel 11, fuselage inner air passageway 9, inner air & vectored air passageway-air diverter cone valve mechanism 49, in the zero diverting position, and inner air & vectored air passageway air diverter cone valve threaded drive rod mechanism 50, and vectored air passageway, air control valve mechanism 51, in the closed position, a plurality of air vectoring mechanisms-air control fins 44, vectored aft, and a plurality of air vectoring mechanisms-fuselage air control fin door 45, in the closed position, a plurality of air vectoring mechanisms funnel air control fin door 46, in the closed position, and bifurcated funnel & fuselage air control fin doors mechanism 47, in the closed position to vector the air flow into the airships fore through the fuselage inner-air passageway inlet funnel 11, and into the fuselage inner air passageway 9;

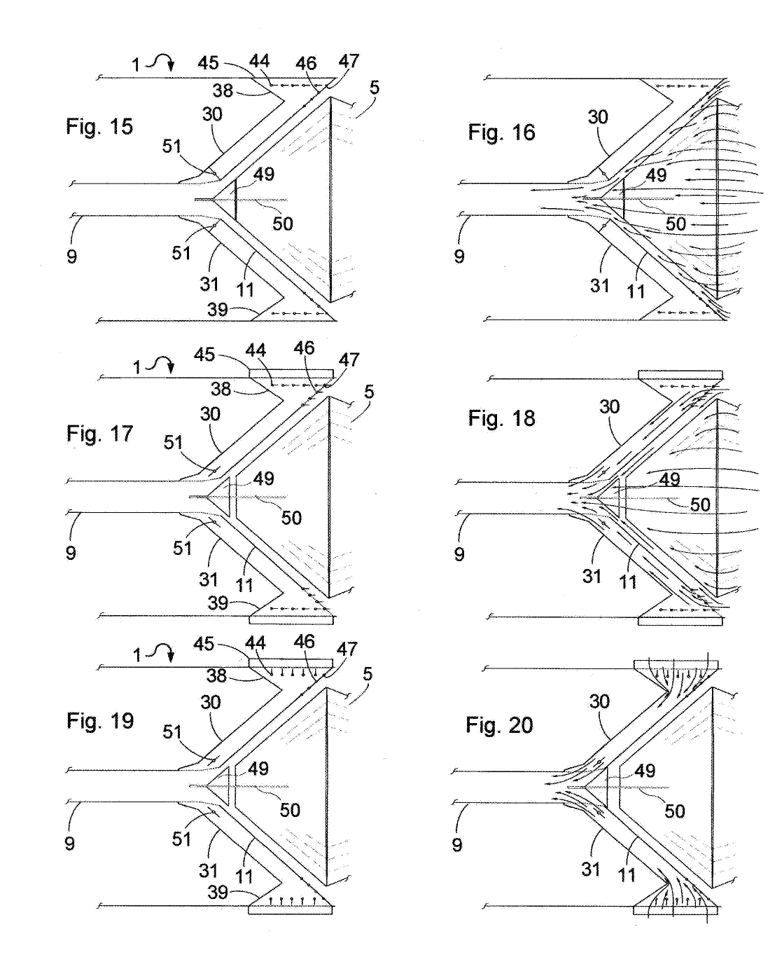

Referring to FIG. 15 is a partial side view of the tubular airship fore as shown and described in FIG. 14 with the inner air & vectored air passageway-air diverter cone valve mechanism 49, in the zero divert position fully retracted onto the inner air & vectored air passageway-air diverter cone valve threaded drive rod mechanism 50, and the vectored air passageway-air control valve mechanism 51, in the closed position, and the air vectoring mechanism fore top 38, & bottom 39, configured to vector the air flow into the airship 1, fuselage inner-air passageway inlet funnel 11, and into the fuselage inner air passageway 9;

Referring to FIG. 16 is a partial side view of the tubular airship fore as shown and described in FIG. 14, and the air flow being shown with the inner air & vectored air passageway-air diverter cone valve mechanism 49, in the zero divert position fully retracted onto the inner air & vectored air passageway-air diverter cone valve threaded drive rod mechanism 50, and the vectored air passageway-air control valve mechanism 51, in the closed position, and the air vectoring mechanism fore top 38, & bottom 39, vectoring the air flow into the airship 1, fuselage inner-air passageway inlet funnel 11, and into the fuselage inner air passageway 9;

Referring to FIG. 17 is a partial side view of the tubular airship fore as shown and described in FIG. 14 with the inner air & vectored air passageway-air diverter cone valve mechanism 49, in the partial divert position partially extended onto the inner air & vectored air passageway-air diverter cone valve threaded drive rod mechanism 50, and the vectored air passageway-air control valve mechanism 51, in the open position, and the air vectoring mechanism fore top 38, & bottom 39, configured to vector the air flow into the airship 1, fuselage inner-air passageway inlet funnel 11, & vectored air passageway fore top 30, & bottom 31 and into the fuselage inner air passageway 9, and with the air vectoring mechanism fore top 38, & bottom 39, fuselage air control fin doors 45, in the open position;

Referring to FIG. 18 is a partial side view of the tubular airship fore as shown and described in FIG. 14, and the air flow being shown with the inner air & vectored air passageway-air diverter cone valve mechanism 49, in the partial divert position partially extended onto the inner air & vectored air passageway-air diverter cone valve threaded drive rod mechanism 50, and the vectored air passageway-air control valve mechanism 51, in the open position, and the air vectoring mechanism fore top 38, & bottom 39, vectoring the air flow into the airship 1, fuselage inner-air passageway inlet funnel 11, & vectored air passageway fore top 30, & bottom 31, and into the fuselage inner air passageway 9, and with the air vectoring mechanism fore top 38, & bottom 39, fuselage air control fin doors 45, in the open position;

Referring to FIG. 19 is a partial side view of the tubular airship fore as shown and described in FIG. 14 with the inner air & vectored air passageway-air diverter cone valve mechanism 49, in the full divert position fully extended onto the inner air & vectored air passageway-air diverter cone valve threaded drive rod mechanism 50, and the vectored air passageway-air control valve mechanism 51, in the open position, and the air vectoring mechanism fore top 38, & bottom 39, configured to vector the air flow into the airship 1, air vectoring mechanism fore top 38, & bottom 39, vectored air passageway fore top 30, & bottom 31, and into the fuselage inner air passageway 9;

Referring to FIG. 20 is a partial side view of the tubular airship fore as shown and described in FIG. 14, and the air flow being shown with the inner air & vectored air passageway-air diverter cone valve mechanism 49, in the full divert position fully extended onto the inner air & vectored air passageway-air diverter cone valve threaded drive rod mechanism 50, and the vectored air passageway-air control valve mechanism 51, in the open position, and the air vectoring mechanism fore top 38, & bottom 39, vectoring the air flow into the airship 1, air vectoring mechanism fore top 38, & bottom 39, vectored air passageway fore top 30, & bottom 31 and into the fuselage inner air passageway 9;

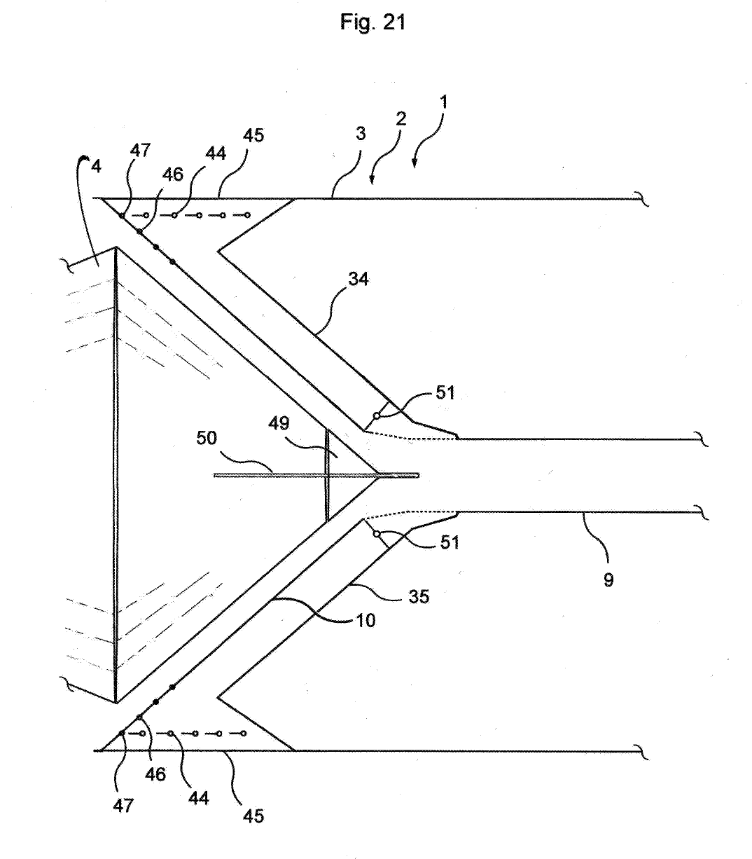

Referring to FIG. 21 a partial side view will be seen of the tubular airship 1, fuselage 2, and straight fuselage tubular hull 3, aft section, and fuselage air deflector cone aft 4, vectored air passageways aft top 34, & aft bottom 35, fuselage inner-air passageway outlet funnel 10, fuselage inner air passageway 9, inner air & vectored air passageway-air diverter cone valve mechanism 49, in the zero diverting position, and inner air & vectored air passageway-air diverter cone valve threaded drive rod mechanism 50, and vectored air passageway-air control valve mechanism 51, in the closed position, air vectoring mechanisms-air control fin 44, vectored aft, and air vectoring mechanisms-fuselage air control fin door 45, in the closed position, air vectoring mechanisms-funnel air control fin doors 46, in the closed position, and air vectoring mechanisms-bifurcated air control fin door 47, in the closed position to vector the air flow into the airships aft through the fuselage inner-air passageway outlet funnel 10, and out of the airship.

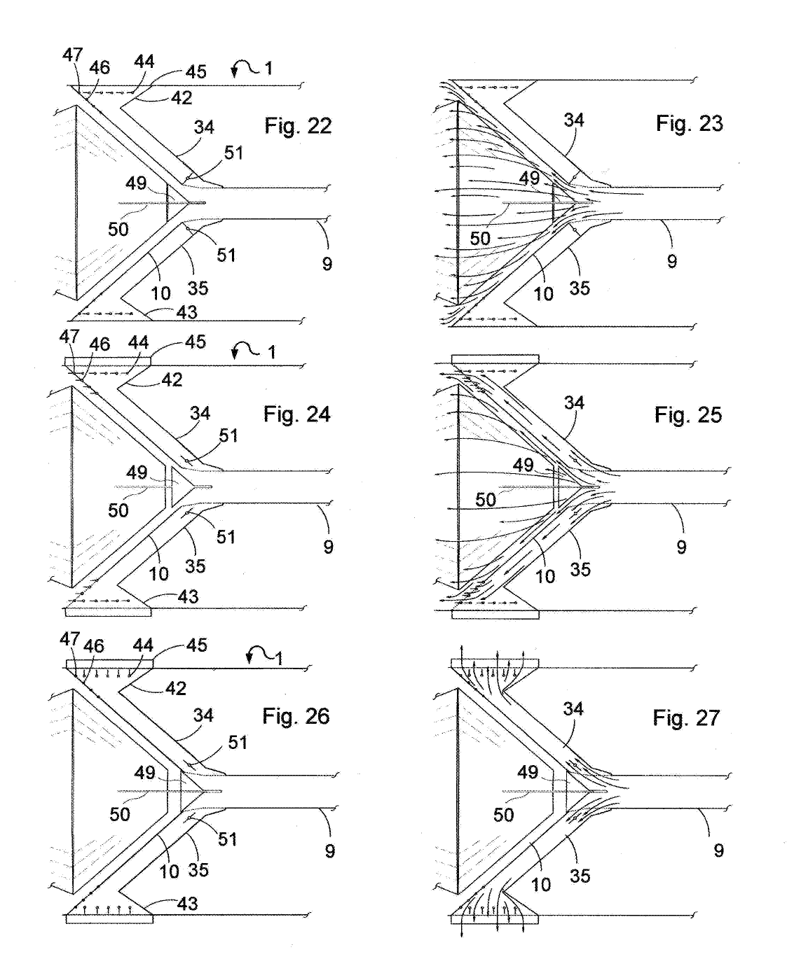

Referring to FIG. 22 is a partial side view of the tubular airship aft as shown and described in FIG. 21 with the inner air & vectored air passageway air diverter cone valve mechanism 49, in the zero divert position fully retracted onto the inner air & vectored air passageway air diverter cone valve threaded drive rod mechanism 50, and the vectored air passageway-air control valve mechanism 51, in the closed position, and the air vectoring mechanism aft top 42, & bottom 43, configured to vector the air flow into the airship 1, fuselage inner-air passageway outlet funnel 10, and out of the airship;

Referring to FIG. 23 is a partial side view of the tubular airship aft as shown and described in FIG. 21, and the air flow being shown with the inner air & vectored air passageway air diverter cone valve mechanism 49, in the zero divert position fully retracted onto the inner air & vectored air passageway air diverter cone valve threaded drive rod mechanism 50, and the vectored air passageway-air control valve mechanism 51, in the closed position, and the air vectoring mechanism aft top 42, & bottom 43, vectoring the air flow into the airship 1, fuselage inner-air passageway outlet funnel 10, and out of the airship;

Referring to FIG. 24 is a partial side view of the tubular airship aft as shown and described in FIG. 21 with the inner air & vectored air passageway air diverter cone valve mechanism 49, in the partial divert position partially extended onto the inner air & vectored air passageway air diverter cone valve threaded drive rod mechanism 50, and the vectored air passageway-air control valve mechanism 51, in the open position, and the air vectoring mechanism aft top 42, & bottom 43, fuselage air control fin doors 45, in the open position, and the air vectoring mechanism aft top 42, & bottom 43, configured to vector the air flow into the airship 1, fuselage inner-air passageway outlet funnel 10, & vectored air passageway all top 34, & bottom 35, and out of the airship;

Referring to FIG. 25 is a partial side view of the tubular airship aft as shown and described in FIG. 21, and the air flow being shown with the inner air & vectored air passageway air diverter cone valve mechanism 49, in the partial divert position partially extended onto the inner air & vectored air passageway air diverter cone valve threaded drive rod mechanism 50, and the vectored air passageway-air control valve mechanism 51, in the open position, and the air vectoring mechanism aft top 42, & bottom 43, fuselage air control fin doors 45, in the open position; and the air vectoring mechanism all top 42, & bottom 43, vectoring the air flow into the airship 1, fuselage inner-air passageway outlet funnel 10, & vectored air passageway aft top 34, & bottom 35, and out of the airship;

Referring to FIG. 26 is a partial side view of the tubular airship aft as shown and described in FIG. 21 with the inner air & vectored air passageway air diverter cone valve mechanism 49, in the full divert position fully extended onto the inner air & vectored air passageway air diverter cone valve threaded drive rod mechanism 50, and the vectored air passageway-air control valve mechanism 51, in the open position, and the air vectoring mechanism aft top 42, & bottom 43, configured to vector the air flow into the airship 1, air vectoring mechanism aft top 42, & bottom 43, vectored air passageway aft top 34, & bottom 35, and out of the airship;

Referring to FIG. 27 is a partial side view of the tubular airship aft as shown and described in FIG. 21, and the air flow being shown with the inner air & vectored air passageway air diverter cone valve mechanism 49, in the full divert position fully extended onto the inner air & vectored air passageway air diverter cone valve threaded drive rod mechanism 50, and the vectored air passageway-air control valve mechanism 51, in the open position, and the air vectoring mechanism aft top 42, & bottom 43, vectoring the air flow into the airship 1, air vectoring mechanism aft top 42, & bottom 43, fuselage inner-air passageway inlet funnel 11, & vectored air passageway all top 34, & bottom 35, and out of the airship;

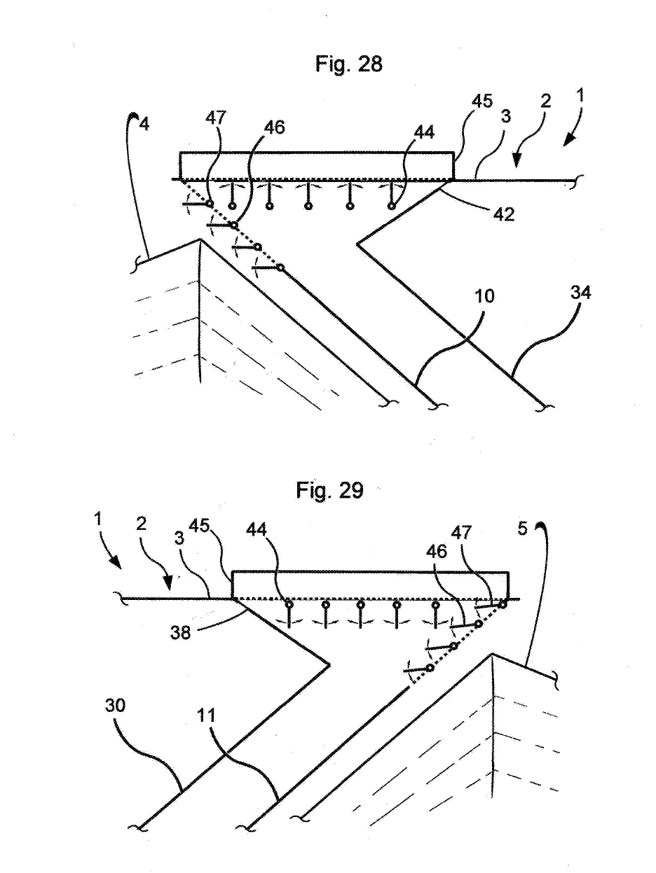

Referring to FIG. 28 a partial side view will be seen of the tubular airship 1, fuselage 2, aft section, and straight fuselage tubular hull 3, fuselage air deflector cone aft 4, vectored air passageways aft top 34, fuselage inner-air passageway outlet funnel 10, a plurality of air vectoring mechanism air control fins 44, are vectored up, and a plurality of air vectoring mechanism fuselage air control fin doors 45, are in the open position, a plurality of air vectoring mechanism funnel air control fin doors 46, are in the open position, and air vectoring mechanisms bifurcated air control fin doors 47, are in the open aft position in order to vector the air flow out of the airship 1, through the air vectoring mechanism aft top 42, & fuselage inner-air passageway outlet funnel 10, thus vectoring airflow both up and aft of the airship 1;

Referring to FIG. 29 a partial side view will be seen of the tubular airship 1, fuselage 2, fore section, and straight fuselage tubular hull 3, fuselage air deflector cone fore 5, vectored air passageways fore top 30, fuselage inner-air passageway inlet funnel 11, a plurality of air vectoring mechanism fuselage air control fin doors 45, are in the open position, a plurality of air vectoring mechanism air control fins 44, are vectored down & inward, and a plurality of air vectoring mechanism funnel air control fin doors 46, are in the open position, and air vectoring mechanism bifurcated air control fin doors 47, are in the open position in order to vector the air flow into the airship 1, air vectoring mechanism fore top 38 fuselage inner-air passageway inlet funnel 11, & vectored air passageway fore top 30, and into the fuselage inner air passageway 9;

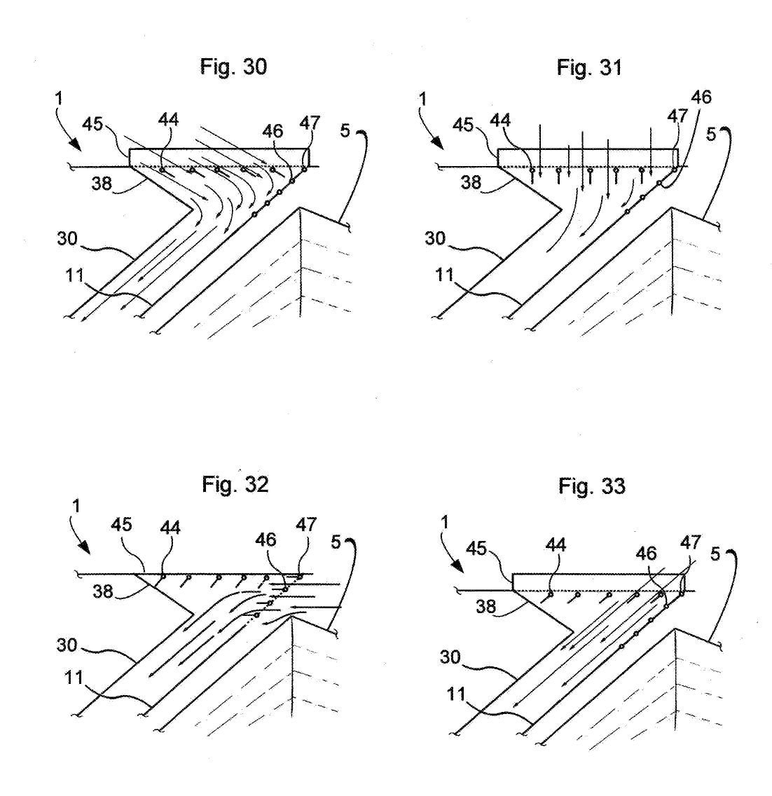

Referring to FIG. 30 a partial side view and understanding of the airflow will be seen of the tubular airship 1, fore as shown and described in FIG. 29 and showing the air flow wherein a plurality of air vectoring mechanism-fuselage air control fin doors 45, are in the open position, a plurality of air vectoring mechanism-air control fins 44, are vectored inward and fore drawing airflow abaft the airship 1, fore, and a plurality of air vectoring mechanism-funnel air control fin doors 46, are in the closed position, and air vectoring mechanism-bifurcated air control fin doors 47, with the funnel door in the closed position and the fuselage door in the open position, thereby vectoring the air flow into the airship 1, air vectoring mechanism fore top 38, inwardly, upwardly abaft the airship 1, fore and into fuselage inner air passageway 9;

Referring to FIG. 31 a partial side view and understanding of the airflow will be seen of the tubular airship 1, fore as shown and described in FIG. 29 and showing the air flow wherein a plurality of air vectoring mechanism-fuselage air control fin doors 45, in the open position, a plurality of air vectoring mechanism-air control fins 44, are vectored inward and upward drawing airflow topside of the airship 1, and a plurality of air vectoring mechanism-funnel air control fin doors 46, are in the closed position, and air vectoring mechanism-bifurcated air control fin doors 47, with the funnel door in the closed position and the fuselage door in the open position, thereby vectoring the air flow into the airship 1, air vectoring mechanism fore top 38, inwardly, topside the airship 1, and into fuselage inner air passageway 9;

Referring to FIG. 32 a partial side view and understanding of the airflow will be seen of the tubular airship 1, fore as shown and described in FIG. 29, wherein a plurality of air vectoring mechanism-fuselage air control fin doors 45, are in the closed position, a plurality of air vectoring mechanism-air control fins 44, are vectored aft, & inwardly and, a plurality of air vectoring mechanism-funnel air control fin doors 46, are in the open position, and air vectoring mechanism-bifurcated air control fin doors 47, with the funnel door in the open position and the fuselage door in the vectored aft position, thereby vectoring the air flow into the airship 1, fuselage inner-air passageway inlet funnel 11, and into the air vectoring mechanism fore top 38, into the vectored air passageway fore top 30, and into fuselage inner air passageway 9;

Referring to FIG. 33 a partial side view and understanding of the airflow will be seen of the tubular airship 1, fore as shown and described in FIG. 29, wherein a plurality of air vectoring mechanism-fuselage air control fin doors 45, are in the open position, a plurality of air vectoring mechanism-air control fins 44, are vectored aft & inwardly and, a plurality of air vectoring mechanism-funnel air control fin doors 46, are in the closed position, and air vectoring mechanism-bifurcated air control fin doors 47, with the funnel door in the closed position and the fuselage door in the open position, thereby vectoring the air flow into the airship 1, air vectoring mechanism fore top 38, inward & upwardly afore of the airship 1, and into fuselage inner air passageway 9;

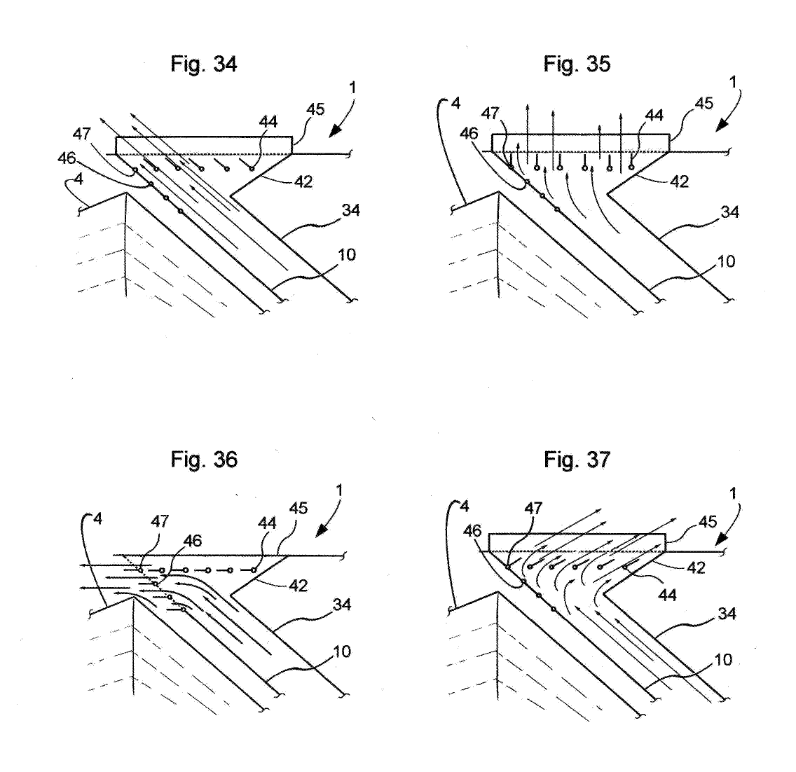

Referring to FIG. 34 a partial side view and understanding of the airflow will be seen of the tubular airship 1, fore as shown and described in FIG. 29, wherein a plurality of air vectoring mechanism-fuselage air control fin doors 45, are in the open position, a plurality of air vectoring mechanism-air control fins 44, are vectored outward and aft, thrusting airflow aft of the airship, and a plurality of air vectoring mechanism-funnel air control fin doors 46, are in the closed position, the air vectoring mechanism-bifurcated air control fin doors 47, with the funnel door in the closed position and the fuselage door in the vectored aft position, thereby vectoring the air flow out of the airship 1, air vectoring mechanism aft top 42, upwardly & aft of the airship 1;

Referring to FIG. 35 a partial side view and understanding of the airflow will be seen of the tubular airship 1, fore as shown and described in FIG. 29, wherein air vectoring mechanisms fuselage air control fin door 45, in the open position, and air vectoring mechanisms air control fins 44, are in the vectored upward vectoring airflow topside of the airship, and a plurality of air vectoring mechanism-funnel air control fin doors 46, are in the closed position, and air vectoring mechanisms bifurcated air control fin door 47, with the funnel door in the closed position and the fuselage door in the open & vectored up position thereby vectoring the air flow out of the airship 1, air vectoring mechanism aft top 42, out & upwardly of the airship 1;

Referring to FIG. 36 a partial side view and understanding of the airflow will be seen of the tubular airship 1, fore as shown and described in FIG. 29, wherein a plurality of air vectoring mechanism-fuselage air control fin doors 45, are in the closed position, a plurality of air vectoring mechanism-air control fins 44, are vectored aft and, a plurality of air vectoring mechanism-funnel air control fin doors 46, are in the open position, and air vectoring mechanism-bifurcated air control fin doors 47, with the funnel door in the open position and the fuselage door vectored aft, thereby vectoring the air flow out of the airship 1, fuselage inner-air passageway outlet funnel 11, out and aft, of the airship 1;

Referring to FIG. 37 a partial side view and understanding of the airflow will be seen of the tubular airship aft as shown and described in FIG. 28, wherein a plurality of air vectoring mechanism-fuselage air control fin doors 45, are in the open position, a plurality of air vectoring mechanism-air control fins 44, are vectored fore & upwardly and, a plurality of air vectoring mechanism-funnel air control fin doors 46, are in the closed position, and air vectoring mechanism-bifurcated air control fin doors 47, with the funnel door in the closed position and the fuselage door vectored fore, thereby vectoring the air flow out of the airship 1, air vectoring mechanism aft top 42, outward, upwardly, & afore of the airship 1;

FIG. 38 is a sectional aft view of the present invention showing the vectored air passageway air vectoring mechanisms positioned in tubular hull 3, aft top, bottom, port & starboard, the fuselage 2, fuselage air deflector cone aft 4, aft bifurcated active & non active horizontal attitudinal control wings 13, aft bifurcated active & non active vertical attitudinal control wings 15, and air vectoring mechanism aft port 40, starboard 41, top 42, & bottom 43;

Referring to FIG. 39 a partial fore view of the present invention as shown and described in FIG. 38 will be seen showing the air flow through the air vectoring mechanism fore top 38, with the plurality of fuselage air control fin doors 45, in the open up position thereby vectoring intake air upwardly from the airship fuselage 2;

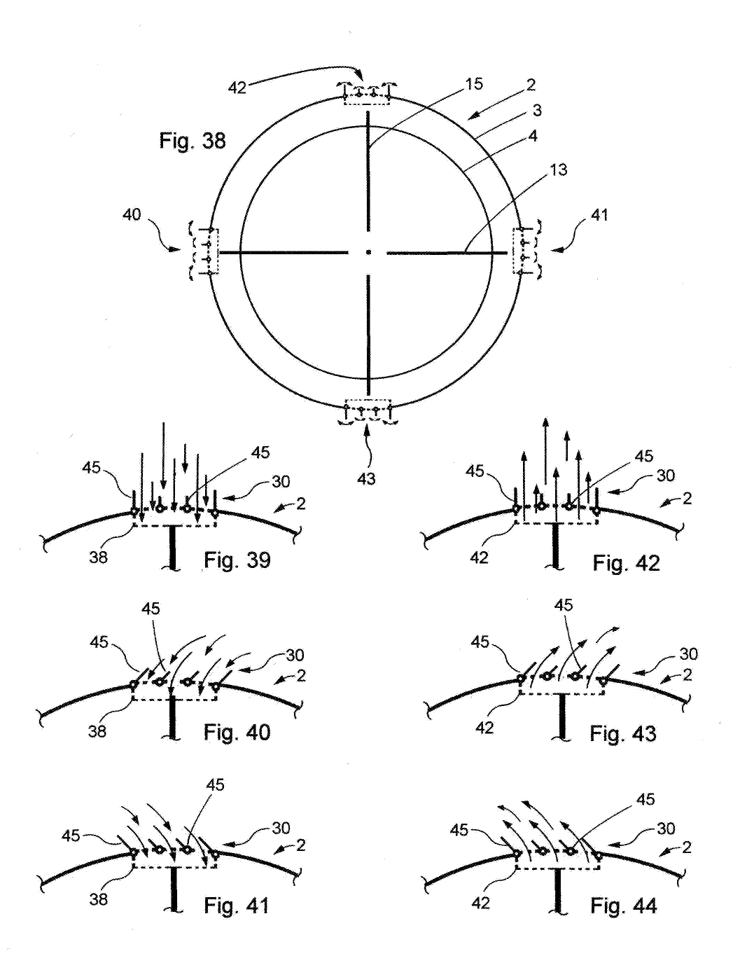

Referring to FIG. 40 a partial fore view of the present invention as shown and described in FIG. 38 will be seen showing the air flow through the air vectoring mechanism fore top 38, with the plurality of fuselage air control fin doors 45, in the open upwardly & astarboard position thereby vectoring intake air upwardly & astarboard from the airship fuselage 2;

Referring to FIG. 41 a partial fore view of the present invention as shown and described in FIG. 38 will be seen showing the air flow through the air vectoring mechanism fore top 38, with the plurality of fuselage air control fin doors 45, in the open upwardly & aport position thereby vectoring intake air upwardly & aport from the airship fuselage 2;

Referring to FIG. 42 a partial aft view of the present invention as shown and described in FIG. 38 will be seen showing the air flow through the air vectoring mechanism aft top 42, with the plurality of fuselage air control fin doors 45, in the open up position thereby vectoring outlet air upwardly from the airship fuselage 2;

Referring to FIG. 43 a partial aft view of the present invention as shown and described in FIG. 38 will be seen showing the air flow through the air vectoring mechanism aft top 42, with the plurality of fuselage air control fin doors 45, in the open upwardly & astarboard position thereby vectoring outlet air upwardly & astarboard from the airship fuselage 2;

Referring to FIG. 44 a partial aft view of the present invention as shown and described in FIG. 38 will be seen showing the air flow through the air vectoring mechanism aft top 42, with the plurality of fuselage air control fin doors 45, in the open upwardly & aport position thereby vectoring outlet air upwardly & aport from the airship fuselage 2;

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept. In addition, the individual components need not be fabricated from the disclosed material, but could be fabricated from virtually any suitable material. Moreover, the individual components need not be formed in the disclosed shapes, or assembled in the disclosed configuration, but could be provided in virtually any shape, and assembled in virtually any configuration. Further, although many elements and components are described herein as physically separate modules, it will be manifest that they may be integrated into the apparatus with which it is associated. Furthermore, all the disclosed features of each disclosed embodiment can be combined with, or substituted for, the disclosed features of every other disclosed embodiment except where such features are mutually exclusive.

### Operation

The manner of using the improved airship as so far described, it will be apparent that by endowing said plurality of resilient gas bags sufficiently for lift with helium or other lighter-than-air gas, and fueling said plurality of propulsion means fuel tanks, and by initiating the jet engine combustion sequence and thereby the air propulsion, that air flow will thereby be directed into the airship fore air intake funnel, around the fore air deflector cone & winged air control surfaces, or through the plurality of fore vectored air passageways & air vectoring mechanisms, into & through the inner air passageway, into & through the engine propulsion means, out through the aft air funnel around the aft air deflector cone & winged air control surfaces, or through the plurality of aft vectored air passageways & air vectoring mechanisms so that by variably increasing and decreasing propulsion means rpm thereby air flow and operate-ably actuating the winged air control surfaces, or plurality of air vectoring mechanisms, said airship is operate-ably controllably flown through the air, with improved speed, maneuverability, efficiency, adverse weather capability, reduced forward air resistance, & rearward drag.

It will further be apparent that by flying the airship as previously described, ascending to altitudes near space using buoyant lift provided by the plurality of resilient gas bags and jet engine propulsion to beyond jet engine oxygen requirements, that by initiating rocket engine propulsion, and attitudinal thrusters, outer atmosphere, and space directional control is thereby provided.

Further that flight of the airship to altitudes below space and into the outer atmosphere and into the inner atmosphere is provided by using rocket engine thrusters & dynamic buoyant lift provided by the plurality of resilient gas bags, further that upon decent into inner atmospheric space to altitude and oxygen levels sufficient for jet engine ignition, jet engine ignition is initiated thereby providing airship propulsion and attitudinal control for inner atmospheric flight.

It will still further be apparent that by operating the airship as afore described and installing explosives materials in the cargo bay that a buoyant missile is herein provided.

I hereby claim:

1. An improved airship comprising:
a linear straight tubular shaped fuselage, said fuselage having an inner air passageway axially extending there-through tapering inwardly from the furthest circumferential peripheral exterior edges of said fuselage fore, toward the interior mid region of said airship like a funnel, forming an air inlet opening in said fuselage fore, connecting to said inner air passageway extending downstream continuing to airship aft tapering outwardly like a funnel to the furthest circumferential peripheral exterior edges of said fuselage aft forming an air outlet opening in aft of said fuselage, said straight tubular shaped fuselage having horizontal and vertical winged control surfaces, and having a means for reducing air displacement, forward air resistance, rearward drag and improved fuel economy speed, maneuverability, high wind gust, and adverse weather capability;
a means for directing airflow into and out of said airship to the circumferential peripheral regions of said air inlet and outlet openings, out of and into said inner air passageway extending through said fuselage, said means for directing airflow comprising a plurality of air deflector cones axially affixed centrally positioned substantially inside and extending from said air inlet and outlet openings in fore and aft in said fuselage;
a means for controlling direction, pitch, roll & yaw, and further means for directing air flow into and out of said airship, said means for controlling direction, pitch, roll & yaw, and directing air flow into and out of said airship, comprising a plurality of bifurcated active and non active hinge-ably, rotate-ably connected winged control surfaces located at the front and rear of said air inlet and outlet inner air way openings, said winged control surfaces being positioned horizontally and vertically across said inner air way openings, said active control surfaces being rotate-ably, hinge-ably, attached to said non active control surfaces, and a plurality of actuators attached between said air intake funnel and air outlet funnel and deflector cone sections of said fuselage to said control surfaces to operate-ably, rotate-ably, actuate said hinged active control surfaces respective to said non active control surfaces, thereby actuate-ably controlling direction of air flow into said air inlet opening and out of said air outlet opening;
a means for containing a plurality of lighter than air resilient gas cells, said means comprising a plurality of containers, said containers comprising said fuselage, fore and aft air deflector cones;
a means of providing lift and atmospheric buoyancy said means provided by a plurality of resilient lighter than air gas bag cells, said gas cells being filled preferably with helium or hydrogen gas;
a further means for providing lift comprises said fore and aft horizontal wing control surfaces, by rotate-ably positioning said active wing control surface relative to incoming and out flowing air so as to effect high and low air pressure areas respectively above and below said fore and aft horizontal wing control surfaces;
a means for propelling said airship located within said inner air passageway;
a means for containing operational equipment & payload bays, said means comprising space located preferably inside lower portion of said fuselage;
a means for reduced radar reflection said means comprising said tubular shaped fuselage said tubular fuselage radial surface reflectively defusing radar waves away from radar receivers;
a means for propulsive control in space, air atmosphere, and transition to and from thereof, said means comprising a main rocket thrust nozzle axially centrally positioned in aft of said aft air deflector cone;
a means for controlling direction, pitch, roll & yaw in space, air atmosphere, and transition to and from thereof, said means comprising a plurality of rocket thrust nozzles positioned fore, aft, top, bottom, left, and right of said fuselage exterior;
a means for further reduced radar cross section said means provided by polygonal tubular fuselage embodiments flat surfaces reflectively defusing radar waves away from the radar receiver;

2. An improved airship as in claim 1 wherein said tubular fuselage has a straight linear tubular hull having a substantially smooth exterior surface of said tubular fuselage, and said fuselage having a fore air inlet opening connecting to said inner air passageway, said air inlet opening tapering inwardly from furthest circumferential peripheral exterior edge of said tubular fuselage fore, defining said air inlet opening, and aft air outlet opening connected to said inner air passageway, said aft air outlet opening tapering outwardly from said inner air passageway to furthest circumferential peripheral exterior edge of said tubular fuselage aft defining said air outlet opening and said inner air passageway, defining said tubular fuselage.

3. An improved airship as in claim 1 wherein said tubular fuselage has air deflector cones said deflector cones positioned fore and aft, centrally affixed within said fuselage inner air passageway inlet and outlet openings.

4. An improved airship as in claim 1 wherein said tubular fuselage comprises a straight tubular hull having a substantially smooth exterior surface of said tubular fuselage.

5. An improved airship as in claim 1 wherein said means for propelling said airship comprising preferably a high by pass jet engine, located within said inner air passageway mid region within said tubular fuselage.

6. An improved airship as in claim 1 wherein said means for thermal protection shielding of jet engine exhaust heat comprising preferably phenolic impregnated carbon ablator material, ablative heat shields, passive or active cooling means.

7. An improved airship as in claim 1 wherein said means for more economical air transportation at higher speeds comprises a plurality of resilient lighter than air gas bag cells, said gas bag cells providing primary method of lift thereby using fuel for propulsion more than lift, a tubular fuselage, internal winged control surfaces, air deflector cones, an inner air passageway, and internal propulsion means thereby providing a more streamlined airship with less forward air resistance, less rearward drag, and no drag from control surface apertures outside the airship fuselage, thereby transporting cargo by air more economically than other means at comparable speeds.

8. An improved airship as in claim 1 wherein said means for reducing forward air resistance said means comprises a tubular fuselage, internal winged control surfaces, air deflector cones, an inner air passageway, internal propulsion means.

9. An improved airship as in claim 1 wherein said a means for reducing rearward drag comprises a tubular fuselage, internal winged control surfaces, air deflector cones, an inner air passageway, and internal propulsion means.

10. An improved airship as in claim 1 wherein said means for reducing external fuselage aerodynamic friction comprises: a tubular fuselage, internal winged control surfaces, air deflector cones, an inner air passageway, and internal propulsion means.

11. An improved airship as in claim 1 wherein said means for attaining higher speeds comprises a tubular fuselage, internal winged control surfaces, air deflector cones, inner air passageway, and internal propulsion means.

12. An improved airship as in claim 1 wherein said means for propelling said airship comprises preferably a jet engine turbo prop having a plurality of propellers connect fore and aft to jet engine located within said inner air passageway mid region within said tubular fuselage.

13. An improved airship as in claim 1 wherein said means for propelling said airship comprises preferably a jet engine turbo shaft driven propellers having a plurality of propellers connected fore and aft to jet engine located within said inner air passageway mid region within said tubular fuselage.
a means for individually directing air flow into and out of said plurality of vectored air passageways & air vectoring mechanisms, said means comprising a plurality of vectored air passageway-air control valve mechanism positioned affixed axially inside said vectored air passageways;
a means for directing airflow into and out of said airship variably fully to-and-from, the airship fuselage inner-air passageway inlet & outlet funnels, and vectored air passageways fore & aft, said means comprising a plurality of inner air & vectored air passageway-air diverter cone valve mechanisms, inner air & vectored air passageway-air diverter cone valve & threaded drive rod mechanisms, vectored air passageway-air control valve mechanisms, and vectored air passageways & air vectoring mechanisms;
a means to vector airflow into & out of said airship, fore, aft, top, bottom, port, & starboard, said means comprising a plurality of air control fins, fuselage air control fin doors, funnel air control fin doors, bifurcated funnel & fuselage air control fin doors mechanisms;
a means for providing said airship guidance, said means comprising a human pilot operating typical spacecraft control & aircraft avionics equipment positioned in typical aircraft cockpit & cabin affixed & positioned preferably in said airship cargo & operating equipment bay area, said avionics actuate-ably connected to said airships said plurality of bifurcated active & non active vertical & horizontal attitudinal control wings, vectored air passageways & air vectoring mechanisms, propulsion means, rocket engines, and other typical spacecraft control & aircraft avionics mechanisms & apparatus;
a means for providing said airship guidance, said means comprising typical unmanned drone spacecraft control & aircraft avionics equipment affixed & positioned preferably in said airship cargo & operating equipment bay area said avionics actuate-ably connected to said airships said plurality of bifurcated active & non active vertical & horizontal attitudinal control wings, vectored air passageways & air vectoring mechanisms, propulsion means, rocket engines, and other typical spacecraft control & aircraft avionics mechanisms & apparatus operate-ably, actuated by human being;
a means for thermal protection shielding from jet engine exhaust said means shielding interior of said inner air passageway around and aft of: engine, said aft air deflector cone, said aft inner air way outlet funnel, and said winged control surfaces;
a means for controlling direction, pitch, roll & yaw, and still further means for directing air flow into and out of said airship, said means comprising a plurality of vectored air passageways & air vectoring mechanisms positioned fore, aft, top, bottom, port & starboard, in said airship;
a means for providing said airship additional thrust vectoring lift and further means for directing airflow into and out of said airship, said means comprising a plurality of vectored air passageways & air vectoring mechanisms, positioned and affixed substantially fore, aft, top, bottom, port & starboard in said airship;
a means for providing said airship substantially no travel afore, or abaft, while providing said airship lateral, vertical, directional, pitch, yaw, and roll movement, said means comprising a plurality of vectored air passageways & air vectoring mechanisms;
a means for controlling said airship direction, pitch, roll & yaw position and further means for directing airflow into and out of said airship, with substantially no forward, reverse & lateral airship movement said means comprising a plurality of vectored air passageways & air vectoring mechanisms, positioned and affixed top, bottom, port & starboard, fore and aft, in said airship; a means for providing said airship lateral & vertical movement and further means for directing airflow into and out of said airship, with substantially no forward or reverse airship movement said means comprising a plurality of vectored air passageways & air vectoring mechanisms, positioned and affixed substantially fore, aft, top, bottom, port & starboard in said airship;
a means for providing said airship forward & reverse movement, and further means for directing airflow into and out of said airship, with substantially no lateral & vertical airship movement said means comprising vectored air passageways & air vectoring mechanisms, positioned and affixed substantially fore, aft, top, bottom, port & starboard in said airship;
a means for providing said airship thermal & audio stealth, said means comprising centrally internally positioned propulsion means within said airship, said airship providing said propulsion means thermal & audio detection shielding;
a further means for providing said airship thermal stealth, said means comprising centrally internally positioned propulsion means, said engine exhaust heat shield, said fuselage inner air passageway, said fuselage inner-air passageway outlet funnel, and said fuselage air deflector cone aft; providing said propulsion means thermal detection shielding;
